(19) United States
(12) Patent Application Publication
(10) Pub. No.: US 2018/0114130 A1
(43) Pub. Date: Apr. 26, 2018

(54) Method And System For Pre-Processing Data Received From Data Sources To Deduce Meaningful Information

(71) Applicant: Loven Systems, LLC, Northville, MI (US)

(72) Inventors: Satyendra Pal RANA, Northville, MI (US); Chandra Puttanna KEERTHY, Northville, MI (US); Krishna Prakash KALLAKURI, Northville, MI (US)

(21) Appl. No.: 15/788,641

(22) Filed: Oct. 19, 2017

Related U.S. Application Data
(60) Provisional application No. 62/410,753, filed on Oct. 20, 2016.

(51) Int. Cl. G06N 5/04; G06N 99/00; H04L 12/24

(52) U.S. Cl. CPC G06N 5/045; G06N 99/005; H04L 67/141; H04L 41/14; G06N 5/046

(57) ABSTRACT

Disclosed is perceptual system for facilitating a stream of data required for data analytics is disclosed. The perceptual system comprises a data ingestion governance module, a data input ports module, a data ingestion module, and an opportunity input packager module. The data ingestion governance module receives an input instruction, from a data analytics system, associated to data required for data analytics. The data ingestion governance module further determines a data source, amongst a plurality of data sources, generating a stream of data. The data input ports module establishes a network connection with the data source in order to extract the stream of data. The data ingestion module transforms the stream of data into a stream of transformed data based on the input instruction. The opportunity input packager module generates a stream of input packets upon including metadata in the stream of transformed data and thereby transmitting the stream of input packets to the data analytics system configured to perform the data analytics on the data.

### CROSS REFERENCE TO RELATED APPLICATIONS

This patent application claims priority from US Provisional Application No. 62/410,753 filed on Oct. 20, 2016, the entirety of which is hereby incorporated by reference.

### TECHNICAL FIELD

The present disclosure described herein, in general, facilitates a stream of data, upon pre-processing, to a data analytics system for deducing meaningful information.

### BACKGROUND

In the age of digital world, enormous amount of data may be generated by a plurality of data sources (such as business data captured from enterprise systems, User Generated Content (UGC), open linked data from internet and from Internet of Things (IoT) devices such as sensors). Since the data plays a key role in optimizing the performance of an organization, there exists a challenge for organizations to filter relevant dataset from the enormous amount of data and thereby deduce meaningful information upon performing data analytics on the dataset. Though there exist various analytics systems for performing data analysis, however providing an optimum dataset required for the data analysis is a challenge.

### SUMMARY

Before the present systems and methods, are described, it is to be understood that this application is not limited to the particular systems, and methodologies described, as there can be multiple possible embodiments which are not expressly illustrated in the present disclosure. It is also to be understood that the terminology used in the description is for the purpose of describing the particular versions or embodiments only, and is not intended to limit the scope of the present application. This summary is provided to introduce concepts related to systems and methods for facilitating a stream of data, upon pre-processing, to a data analytics system and the concepts are further described below in the detailed description. This summary is not intended to identify essential features of the claimed subject matter nor is it intended for use in determining or limiting the scope of the claimed subject matter.

In one implementation, a perceptual system for facilitating a stream of data required for data analytics is disclosed. The perceptual system comprises a processor and a memory coupled to the processor. The processor is capable of executing a plurality of modules stored in the memory. The perceptual system comprises a data ingestion governance module, a data input ports module, a data ingestion module, and an opportunity input packager module. The data ingestion governance module may receive an input instruction, from a data analytics system, associated to data required for data analytics. The data ingestion governance module may further determine a data source, amongst a plurality of data sources, generating a stream of data. In one aspect, the data source may be determined based on a predefined mapping of a type of the data analytics, to be performed, with one or more data sources of the plurality of data sources. The data input ports module may establish a network connection with the data source in order to extract the stream of data. The data ingestion module may transform the stream of data into a stream of transformed data based on the input instruction. In one aspect, the stream of data may be transformed upon performing at least one data transformation technique. The opportunity input packager module may generate a stream of input packets upon including metadata in the stream of transformed data and thereby transmitting the stream of input packets to the data analytics system configured to perform the data analytics on the data in a cognitive decision-making process.

In another implementation, a method for facilitating a stream of data required for data analytics is disclosed. In order to facilitate the stream of data, initially, an input instruction may be received from a data analytics system. In one aspect, the input instruction may be associated to data required for data analytics. Upon receiving the input instruction, a data source, amongst a plurality of data sources, generating a stream of data may be determined. In one aspect, the data source may be determined based on a predefined mapping of a type of the data analytics, to be performed, with one or more data sources of the plurality of data sources. Subsequent to the determination of the data source, a network connection may be established with the data source in order to extract the stream of data. Thereafter, the stream of data may be transformed into a stream of transformed data based on the input instruction. In one aspect, the stream of data may be transformed upon performing at least one data transformation technique. Upon transformation of the stream of data, a stream of input packets may be generated upon including metadata in the stream of transformed data and thereby transmitting the stream of input packets to the data analytics system configured to perform the data analytics on the data in a cognitive decision-making process. In one aspect, the aforementioned method facilitating the stream of data may be performed by a processor using programmed instructions stored in a memory of the perceptual system.

In yet another implementation, a non-transitory computer readable medium embodying a program executable in a computing device for facilitating a stream of data required for data analytics is disclosed. The program may comprise a program code for receiving an input instruction, from a data analytics system, associated to data required for data analytics. The program may further comprise a program code for determining a data source, amongst a plurality of data sources, generating a stream of data, wherein the data source is determined based on a predefined mapping of a type of the data analytics, to be performed, with one or more data sources of the plurality of data sources. The program may further comprise a program code for establishing a network connection with the data source in order to extract the stream of data. The program may further comprise a program code for transforming the stream of data into a stream of transformed data based on the input instruction, wherein the stream of data is transformed upon performing at least one data transformation technique. The program may further comprise a program code for generating a stream of input packets upon including metadata in the stream of transformed data and thereby transmitting the stream of input packets to the data analytics system configured to perform the data analytics on the data in a cognitive decision-making process.

### BRIEF DESCRIPTION OF THE DRAWINGS

The foregoing detailed description of embodiments is better understood when read in conjunction with the appended drawing. For the purpose of illustrating the disclosure, there is shown in the present document example constructions of the disclosure; however, the disclosure is not limited to the specific methods and apparatus disclosed in the document and the drawings.

The detailed description is described with reference to the accompanying figure. In the figure, the left-most digit(s) of a reference number identifies the figure in which the reference number first appears. The same numbers are used throughout the drawings to refer like features and components.

FIG. 1 illustrates a network implementation of a perceptual system for facilitating a stream of data required for data analytics is shown, in accordance with an embodiment of the present disclosure.

FIG. 2 illustrates the perceptual system, in accordance with an embodiment of the present disclosure.

FIG. 3 illustrates a method for facilitating the stream of data required for the data analytics is shown, in accordance with an embodiment of the present disclosure.

The figure depicts an embodiment of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that, the singular forms “a,” “an,” and “the” include plural references unless the context clearly dictates otherwise. Although any apparatuses and methods similar or equivalent to those described herein can be used in the practice or testing of embodiments of the present disclosure, the exemplary, apparatuses and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

The present invention provides a method and system for facilitating a stream of data, upon pre-processing, to a data analytics system. In order to deduce meaningful information, the data analytics system provides an input instruction to a perceptual system configured to provide data to the data analytics system for performing data analytics. The perceptual system, based on the input instruction, may receive data streams from one or more data sources. The data streams may be received upon making the required connections with the one or more data sources.

The perceptual system further prepares a data package from the data streams, as continually arriving from the one or more data sources, in pre-defined structure appropriate for performing the data analytics. In one aspect, the data package may be prepared in the pre-defined structure based on the input instruction provided by the data analytics system. In other words, the perceptual system runs the data streams through a data ingestion pipeline (program) to transform the data streams in a form suitable for the data analytics. The transformation may involve fixing of data transmission errors, eliminating semantic errors, including missing data, and changing data format.

Upon transformation of the data streams, the perceptual system generates a stream of input packets by including metadata as well as historical data in the data streams. Subsequently, the perceptual system transmits the stream of input packets to the analytics system that performs the data analytics on the stream of input packet, in order to deduce the meaningful information, used in a cognitive decision-making process. While aspects of described system and method for facilitating the stream of data required for the data analytics may be implemented in any number of different computing systems, environments, and/or configurations, the embodiments are described in the context of the following exemplary perceptual system.

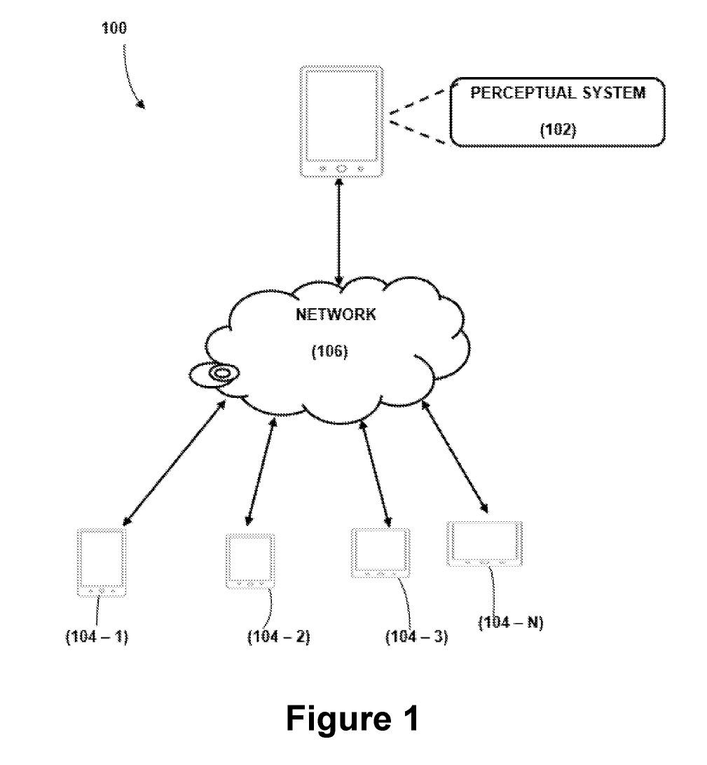

Referring now to FIG. 1, a network implementation 100 of a perceptual system 102 for facilitating a stream of data required for data analytics in a cognitive decision-making process is disclosed. In order to facilitate the stream of data, initially, the perceptual system 102 receives an input instruction from a data analytics system (not shown). Upon receiving the input instruction, the perceptual system 102 determines a data source, amongst a plurality of data sources, generating a stream of data. Subsequent to the determination of the data source, the perceptual system 102 establishes a network connection with the data source in order to extract the stream of data. Thereafter, the perceptual system 102 transforms the stream of data into a stream of transformed data based on the input instruction. Upon transformation of the stream of data, the perceptual system 102 generates a stream of input packets upon including metadata in the stream of transformed data and thereby transmitting the stream of input packets to the data analytics system configured to perform the data analytics on the data.

Although the present disclosure is explained considering that the perceptual system 102 is implemented on a single server, it may be understood that the perceptual system 102 may also be implemented in a Distributed Computing Environment (DCE), involving variety of computing systems operating in parallel. Examples of the computing systems may include, but not limited to, a laptop computer, a desktop computer, a notebook, a workstation, a mainframe computer, a server, a network server, and the like. It will be understood that the perceptual system 102 may be accessed by multiple users through one or more user devices 104-1, 104-2, 104-3; 104-N. In one implementation, the perceptual system 102 may comprise the cloud-based computing environment in which a user may operate individual computing systems configured to execute remotely located applications. Examples of the user devices 104 may include, but are not limited to, a portable computer, a personal digital assistant, a handheld device, and a workstation. The user devices 104 are communicatively coupled to the perceptual system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

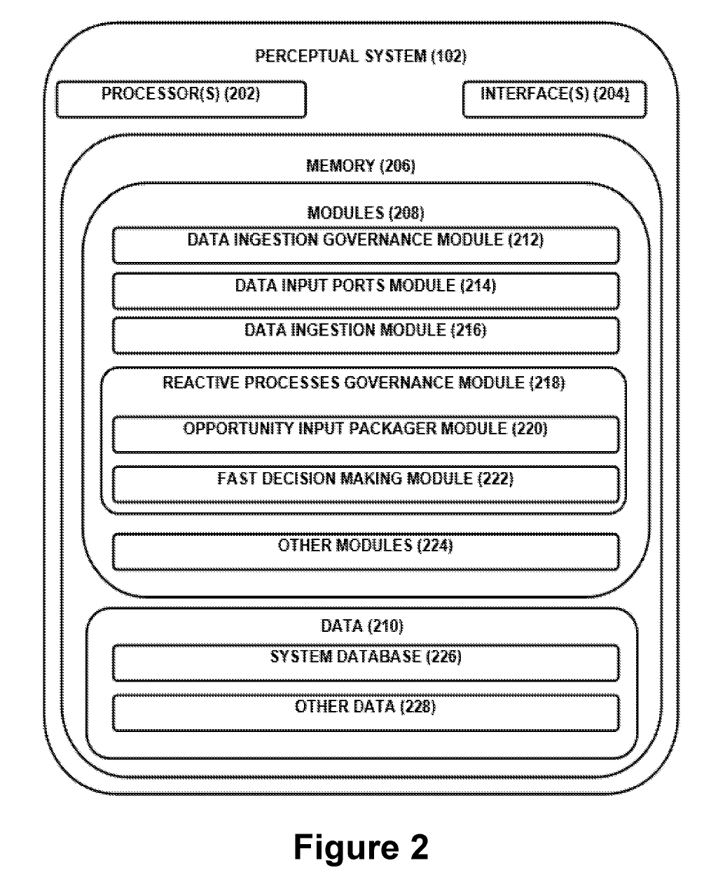

Referring now to FIG. 2, the perceptual system 102 is illustrated in accordance with an embodiment of the present subject matter. In one embodiment, the perceptual system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the perceptual system 102 to interact with the user directly or through the client devices 104. Further, the I/O interface 204 may enable the perceptual system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random-access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks or implement particular abstract data types. In one implementation, the modules 208 may include a data ingestion governance module 212, a data input ports module 214, a data ingestion module 216, a reactive processes governance module 218, and other modules 224. The other modules 224 may include programs or coded instructions that supplement applications and functions of the perceptual system 102. In one embodiment, the reactive processes governance module 218 further comprises an opportunity input packager module 220 and a fast decision-making module 222. The modules 208 described herein may be implemented as software modules that may be executed in the cloud-based computing environment of the perceptual system 102.

The data 210, amongst other things, serves as a repository for storing data processed, received, and generated by one or more of the modules 208. The data 210 may include data generated as a result of the execution of one or more modules in the other modules 224. Further, the data 210 may include a system database 226 and other data 228. The other data 228 may include data generated as a result of the execution of one or more modules in the other modules 224.

As there are various challenges observed in the existing art, the challenges necessitate the need to build the perceptual system 102 for facilitating a stream of data required for data analytics. To facilitate the stream of data, the perceptual system 102 may employ the data ingestion governance module 212, the data input ports module 214, the data ingestion module 216, the reactive processes governance module 218, the opportunity input packager module 220, and the fast decision-making module 222. The detail functioning of the modules is described below with the help of figures. The detailed description of the modules 208 along with other components of the perceptual system 102 is further explained by referring to FIG. 2.

The data ingestion governance module 212 receives an input instruction, from the data analytics system (not shown), associated to data required for data analytics. It may be understood that data analytics system may request the perceptual system 102 to provide the data in order to deduce meaningful information in a cognitive decision-making process. In one aspect, the input instruction may indicate a pattern of data needed by the analytics system for performing the data analytics. In one aspect, the input instruction comprises a type of data, one or more data fields to be included for the data analytics, and a frequency of receiving the data.

Upon receiving the input instruction, the data ingestion governance module 212 determines a data source amongst a plurality of data sources. It may be understood that the data source, determined, is generating a stream of data in a continuous manner. In one aspect, the data source may be determined based on a predefined mapping of a type of the data analytics, to be performed, with one or more data sources of the plurality of data sources. Based on the determination of the data source, the data input ports module 214 establishes a network connection with the data source in order to extract the stream of data.

Upon establishing the network connection with the data source, the data ingestion governance module 212 further maintains metadata associated to the data source. The metadata may include, but not limited to, description and/or address of the data source, procedure to establish connection to the data source, procedure to receive data from the data source.

In one embodiment, the data ingestion governance module 212 may further provide a governance interface for the user to perform at least one operation. The at least one operation may include, not limited to, defining and/or adding a new data source, removing an existing data source, modifying the metadata of the data source, testing the connectivity of the data source, establishing connection to the data source, receiving data from the data source, and scheduling data ingestion jobs to fetch/receive data from the data source.

In other words, the functionality to be performed by the data ingestion governance module 212 is described as follows.

In Initialization Phase, tests connection established with the data source, maintain a log of malfunctioning connections. For all correctly functioning connections, schedule data transfer jobs.

In Execution Phase, monitor the connection established with the data source, monitor the data transfer jobs to check if any error occurred while transferring, restart jobs or initiate failure recovery mechanisms if an error occurred, interact with an administrative user of the one or more data sources to perform operations including, but not limited to, add new data sources, delete existing data sources, view the state of data transfer jobs, modify configurable parameters of data transfer jobs, stop and restart data transfer jobs for testing and/ or failure recovery purposes.

In Termination Phase, the data ingestion governance module 212 is initialized, when the system is initialized and continues to be active until, the perceptual system 102 halts or there is some fault in the perceptual system which brings it down to halt.

After receiving the data from the one or more data sources, the data input ports module 214 programmatically ingests the data into the perceptual system 102 via one or more data input ports. In one aspect, each data input port facilitates to transfer the data received from the data source. In one aspect, the one or more data input ports are created and managed (terminated, restarted, configured) by the data ingestion governance module 212.

In other words, the functionality to be performed by the data input ports module 214 is described as follows.

In Initialization Phase, get connectivity information pertaining to the data source from description of the data transfer jobs and thereby establish the connection with the data source to initiate transferring of the data.

In Execution Phase (repeat in loop until the data transfer job is completed):

1. If query job
i) Submit a query to extract the stream of data
ii) Wait for the stream of data to arrive from the data source
iii) Receive the stream of data
iv) Send the stream of data to be consumed by the data ingestion module 216. In one aspect, the query may be sent to the data source in a sequential manner.

2. If streaming job:
i) Receive a stream of data from the data source for a predefined time interval
ii) Send the next stream of data to be consumed by the data ingestion module 216.

In Termination Phase, if the transfer of the stream of data is not a repeated task, the connection with the data source is closed when the task is finished. Thereby the data input port, facilitating transferring of data, is deactivated.

Once the stream of data ingested into the perceptual system 102, the data ingestion module 216 transforms the stream of data into a stream of transformed data based on the input instruction. In one aspect, the stream of data may be transformed upon performing at least one data transformation technique. In other words, the data ingestion module 216 runs the stream of data through a data ingestion pipeline (program) to transform the raw data in a form suitable for analysis. In one aspect, the data ingestion pipeline analyzes the stream of data in real time as it arrives and extracts meaningful data required for subsequent analytics and discards the rest. During the data ingestion, the perceptual system 102 further ensures that no meaningful data gets discarded because of mismatch in speeds of incoming stream and data ingestion and thereby the logical order of streaming data is preserved. The data ingestion pipeline is declarative specification, for example, using JSON notation, and may be programmatically altered to dynamically alter the semantics of data ingestion based on learning in downstream cognitive processes. Examples of the at least one transformation technique may include, but not limited to, fixing of data transmission errors, correcting semantic errors in raw data, including missing data, and changing data format.

The functionality to be performed by the data ingestion module 216 is described as follows.

In Initialization Phase, specifications of the data ingestion pipeline for each data input port may be received from an external system and thereby initialize the data transfer jobs in accordance with the specifications.

In Execution Phase, receive the stream of data from the data input ports, transform the stream of data through the data ingestion pipeline and notify the opportunity input packager module 220.

After transformation of the stream of data, the reactive processes governance module 218 is invoked. In one embodiment, the reactive processes governance module 218 comprises the opportunity input packager module 220. The opportunity input packager module 220 generates a stream of input packets upon including metadata in the stream of transformed data. In one aspect, the reactive processes governance module 218 invokes further computation to be performed on the stream of input packets based on predefined policies and rules that depend on the meaning of arriving data stream and the cognitive decision-making processes involved. The opportunity input packager module 220 searches for the relevant metadata including business policies and rules and attaches with the stream of data.

For example, consider a stream of data pertaining to a Point-of-Sales (POS) data. A business policy may include a directive to ignore transactions pertaining to returns and exchanges. It may be noted that the POS data may not have the complete information about a customer or a sales person which may be attached as additional meta-data after retrieving from a pre-defined knowledge source. The metadata about models developed from historical data may be included in the stream of input packets that may then be applied in the downstream analysis.

In one aspect, the opportunity input packager module 220 is adapted to initiate a reactive process i.e. a process for sensing a business opportunity based on the stream of input packets. The functionality to be performed by the opportunity input packager module 220 is defined as follows.

In Initialization Phase, the opportunity input packager module 220 performs the following activities:
1) Perform the initialization work required to start receiving the stream of transformed data from the data ingestion module 216. In one aspect, the initialization work depends on the communication mechanism used for transferring the stream of transformed data from the data ingestion module 216 to opportunity input packager module 220. For example, if a message queue is implemented, initialization may require subscribing the opportunity input packager module 220 to the message queue as a ‘consumer’ whereas the data ingestion module 216 appends the stream of transformed data as a ‘producer’.
2) Generate a stream of input packets upon including the metadata in the stream of transformed data.
3) Start receiving the stream of input packets.

In Execution Phase, the opportunity input packager module 220 executes the following actions in a loop:
1) Receive next stream of transformed data from the data ingestion module 216.
2) Insert the next stream of transformed data into an opportunity input package and thereby providing the opportunity input package to an opportunity sensing system for determining a business opportunity. This may require format conversions, as per the input instructions.
3) If the opportunity input package, containing the stream of input packets, may require additional input packets for determining the business opportunity:
   a. Send the current opportunity input package to an opportunity sensing system by using a communication mechanism.
   b. Create a new opportunity input package which now becomes the current opportunity input package and then insert the metadata
   c. Go to step 1.

In Termination Phase, the opportunity input packager module 220 continues to be active after initialization until, the perceptual system 102 halts or there is some fault in the system which brings it down.

In addition to the opportunity input packager module 220, the reactive processes governance module 218 further comprises the fast decision making module 222. In one aspect, the opportunity input packager module 220 is responsible for executing fast real-time processes that consume the stream of input packets and produce real-time analysis views, recommendations and actionable guidance, for end-user without manual intervention, for determining the business opportunity. Each fast decision making process is associated with an executable process specification comprising one or more parameters. The one or more parameters may comprise default values, defined by the user, or dynamically learned and adjusted by the perceptual system 102 using a machine learning algorithm.

In other words, the functionality to be performed by the fast decision making module 222 is defined as follows.

In Initialization Phase, the fast decision making module 222 performs the following activities:
1) Get the executable process specification of a fast decision making process from an external system.
2) Using the executable process specification, launch a stream-processing pipeline program. The stream-processing pipeline program performs time-series analysis or run other incremental analytics algorithms to produce views, recommendations, and actionable guidance in real-time.
3) Receiving the stream of transformed data as specified in the executable process specification.

In Execution Phase, the fast decision making module 222 executes the following steps in a loop:
1) Receive next stream of transformed data.
2) Do processing to produce a fast decision output.
3) Displays the fast decision output to the user.

In Termination Phase, the fast decision making module 222 continues to be active after initialization until, the perceptual system 102 halts or there is some fault in the system which brings it down.

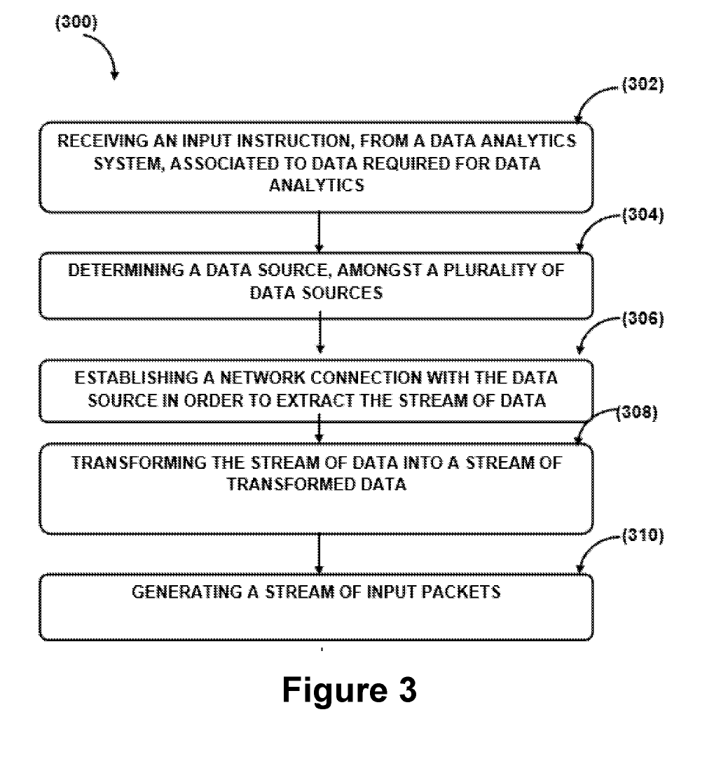

Referring now to FIG. 3, a method 300 for facilitating a stream of data required for data analytics is shown, in accordance with an embodiment of the present subject matter. The method 300 may be described in the general context of computer executable instructions. Generally, computer executable instructions can include routines, programs, objects, components, data structures, procedures, modules, functions, etc., that perform particular functions or implement particular abstract data types. The method 300 may also be practiced in a distributed computing environment where functions are performed by remote processing devices that are linked through a communications network. In a distributed computing environment, computer executable instructions may be located in both local and remote computer storage media, including memory storage devices.

The order in which the method 300 is described is not intended to be construed as a limitation, and any number of the described method blocks can be combined in any order to implement the method 300 or alternate methods. Additionally, individual blocks may be deleted from the method 300 without departing from the spirit and scope of the subject matter described herein. Furthermore, the method can be implemented in any suitable hardware, software, firmware, or combination thereof. However, for ease of explanation, in the embodiments described below, the method 300 may be considered to be implemented as described in the perceptual system 102.

At block 302, an input instruction, from a data analytics system, associated to data required may be received for data analytics. In one implementation, the input instruction may be received by the ingestion governance module 212.

At block 304, a data source, amongst a plurality of data sources, generating a stream of data may be determined. In one aspect, the data source may be determined based on a predefined mapping of a type of the data analytics, to be performed, with one or more data sources of the plurality of data sources. In one implementation, the data source may be determined by the ingestion governance module 212.

At block 306, a network connection may be established with the data source in order to extract the stream of data. In one implementation, the network connection may be established by the data input ports module 214.

At block 308, the stream of data may be transformed into a stream of transformed data based on the input instruction. In one aspect, the stream of data may be transformed upon performing at least one data transformation technique. In one implementation, the stream of data may be transformed by the data ingestion module 216.

At block 310, a stream of input packets may be generated upon including metadata in the stream of transformed data and thereby transmitting the stream of input packets to the data analytics system configured to perform the data analytics on the data in a cognitive decision-making process. In one implementation, the stream of input packets may be generated by the opportunity input packager module 220.

1. A method for facilitating a stream of data required for data analytics, the method comprising:
receiving, by a processor, an input instruction, from a data analytics system, associated to data required for data analytics;
determining, by a processor, a data source, amongst a plurality of data sources, generating a stream of data, wherein the data source is determined based on a predefined mapping of a type of the data analytics, to be performed, with one or more data sources of the plurality of data sources;
establishing, by the processor, a network connection with the data source in order to extract the stream of data;
transforming, by the processor, the stream of data into a stream of transformed data based on the input instruction, wherein the stream of data is transformed upon performing at least one data transformation technique; and
generating, by the processor, a stream of input packets upon including metadata in the stream of transformed data and thereby transmitting the stream of input packets to the data analytics system configured to perform the data analytics on the data in a cognitive decision-making process.

2. The method of claim 1, wherein the input instruction comprises a type of data, one or more data fields to be included for the data analytics, and a frequency of receiving the data.

3. The method of claim 1, wherein the determination of the data source includes a network path of the data source, procedure to establish connection to the data source, and procedure to extract data from the data source.

4. The method of claim 1, wherein the at least one data transformation technique comprises fixing of data transmission errors, correcting semantic errors in raw data, including missing data, and changing data format.

5. The method of claim 1, wherein the metadata comprises pre-defined business policies and business rules, models developed from historical data, and hyper-parameters of models learned over time.

6. A perceptual system for facilitating a stream of data required for data analytics, the perceptual system comprising:
a processor; and
a memory coupled to the processor, wherein the processor is capable of executing a plurality of modules stored in the memory, and wherein the plurality of modules comprising:
a data ingestion governance module for
receiving an input instruction, from a data analytics system, associated to data required for data analytics, and
determining a data source, amongst a plurality of data sources, generating a stream of data, wherein the data source is determined based on a predefined mapping of a type of the data analytics, to be performed, with one or more data sources of the plurality of data sources;
a data input ports module for establishing a network connection with the data source in order to extract the stream of data;
a data ingestion module for transforming the stream of data into a stream of transformed data based on the input instruction, wherein the stream of data is transformed upon performing at least one data transformation technique; and
an opportunity input packager module for generating a stream of input packets upon including metadata in the stream of transformed data and thereby transmitting the stream of input packets to the data analytics system configured to perform the data analytics on the data in a cognitive decision-making process.

7. The perceptual system of claim 6, wherein the input instruction comprises a type of data, one or more data fields to be included for the data analytics, and a frequency of receiving the data.

8. The perceptual system of claim 6, wherein the data ingestion governance module further determines a network path of the data source, procedure to establish connection to the data source, and procedure to extract data from the data source.

9. The perceptual system of claim 6, wherein the data ingestion module transforms the stream of data by at least one of fixing of data transmission errors, correcting semantic errors in raw data, including missing data, and changing data format.

10. The perceptual system of claim 6, wherein the metadata comprises pre-defined business policies and business rules, models developed from historical data, and hyper-parameters of models learned over time.

11. A non-transitory computer readable medium embodying a program executable in a computing device for facilitating a stream of data required for data analytics, the program comprising a program code:
a program code for receiving an input instruction, from a data analytics system, associated to data required for data analytics;
a program code for determining a data source, amongst a plurality of data sources, generating a stream of data, wherein the data source is determined based on a predefined mapping of a type of the data analytics, to be performed, with one or more data sources of the plurality of data sources;
a program code for establishing a network connection with the data source in order to extract the stream of data;
a program code for transforming the stream of data into a stream of transformed data based on the input instruction, wherein the stream of data is transformed upon performing at least one data transformation technique; and
a program code for generating a stream of input packets upon including metadata in the stream of transformed data and thereby transmitting the stream of input packets to the data analytics system configured to perform the data analytics on the data in a cognitive decision-making process.
